(19) United States
(12) Patent Application Publication
(10) Pub. No.: US 2015/0074490 A1
(43) Pub. Date: Mar. 12, 2015

(54) NONVOLATILE SEMICONDUCTOR MEMORY DEVICE

(71) Applicant: Kabushiki Kaisha Toshiba, Minato-ku (JP)

(72) Inventor: Yoshihisa KONDO, Fujisawa-shi (JP)

(73) Assignee: Kabushiki Kaisha Toshiba, Minato-ku (JP)

(21) Appl. No.: 14/191,777

(22) Filed: Feb. 27, 2014

Related U.S. Application Data
(60) Provisional application No. 61/874,522, filed on Sep. 6, 2013.

(51) Int. Cl. G06F 11/10

(52) U.S. Cl. CPC G06F 11/1076
USPC 714/764

(57) ABSTRACT

According to an embodiment, a nonvolatile semiconductor memory device includes a nonvolatile memory, an ECC decoder, and a write controller. The nonvolatile memory includes a memory cell array and a buffer. The buffer is capable of storing page data read from the memory cell array and generating degeneration data by performing an exclusive OR operation on page data read from the memory cell array. The ECC decoder is capable of performing ECC decode on the degeneration data input from the nonvolatile memory and determining whether the degeneration data passes ECC decode or not. The write controller is capable of causing the nonvolatile memory to rewrite the plurality of page data when the degeneration data does not pass ECC decode.

### CROSS-REFERENCE TO RELATED APPLICATIONS

This application claims the benefit of U.S. Provisional Application No. 61/874,522, filed Sep. 6, 2013, the entire contents of which are incorporated herein by reference.

### FIELD

Embodiments relate to a nonvolatile semiconductor memory.

### BACKGROUND

After data is written to a nonvolatile semiconductor memory (for example, a NAND memory), a verification process may be carried out to verify whether or not the data can be correctly read (that is, the data can be decoded). If the result of the verification is negative, an occurrence of a possible read error in a memory device can be prevented by carrying out a recovery process of, for example, rewriting the data to another block. However, the verification process includes a process with high computational complexity such as decoding of an error correction code (ECC), thus the verification process makes it difficult to speed up the write operation and to reduce power consumption.

### BRIEF DESCRIPTION OF THE DRAWINGS

FIG. 1 is a block diagram illustrating a NAND memory device according to a first embodiment;

FIG. 2 is a block diagram illustrating a NAND memory in FIG. 1;

FIG. 3 is a diagram illustrating a page buffer in FIG. 2;

FIG. 4 is a flowchart illustrating a process of verifying a write operation which process is carried out by the NAND memory device in FIG. 1;

FIG. 5 is a diagram illustrating degeneration data;

FIG. 6 is a block diagram illustrating a NAND memory device according to a fourth embodiment; and

FIG. 7 is a block diagram illustrating a NAND memory in FIG. 6.

### DETAILED DESCRIPTION

Embodiments will be described below with reference to the drawings.

According to an embodiment, a nonvolatile semiconductor memory device includes a nonvolatile memory and a controller. The nonvolatile semiconductor memory includes a memory cell array and a buffer. The buffer is capable of storing page data read from the memory cell array and generating degeneration data by performing an exclusive OR operation on a plurality of page data read from the memory cell array. The controller includes an ECC decoder and a write controller. The ECC decoder is capable of performing ECC decode on the degeneration data input from the nonvolatile memory and determining whether the degeneration data passes the ECC decode or not. The write controller is capable of causing the nonvolatile memory to rewrite the plurality of page data when the degeneration data does not pass the ECC decode.

Elements identical or similar to described elements are hereinafter denoted by identical or similar reference numerals, and duplicate descriptions are basically omitted.

### First Embodiment

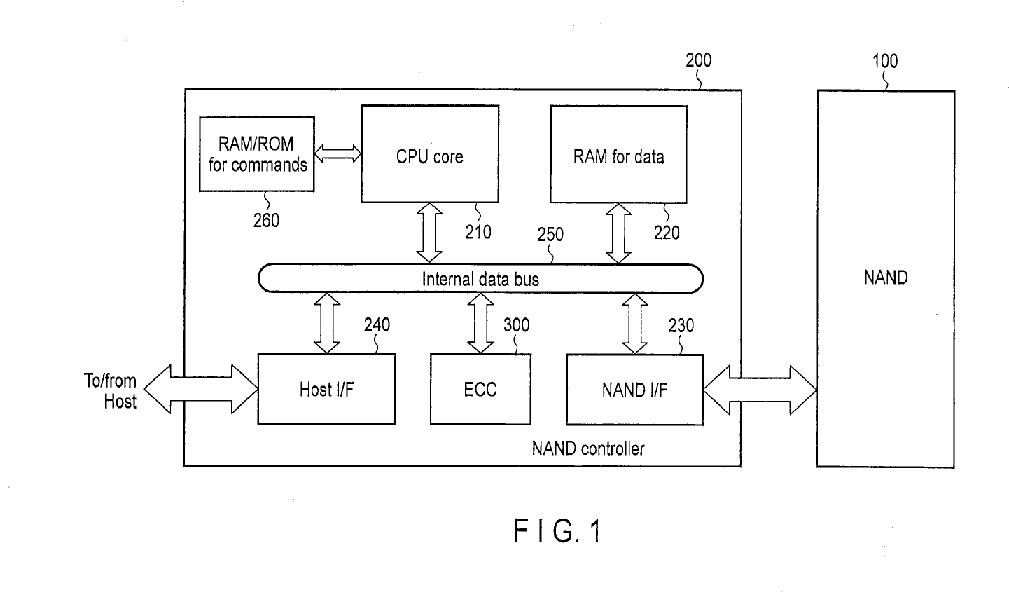

As illustrated in FIG. 1, a NAND memory device according to a first embodiment comprises a NAND memory 100 and a NAND controller 200.

The NAND controller 200 controls the NAND memory 100. Moreover, the NAND controller 200 can transmit and receive data to and from a host (not shown in the drawings). The host may be any information processing apparatus such as a personal computer.

For example, in accordance with an access command provided by the host, the NAND controller 200 writes data received from the host to the NAND memory 100 or reads data from the NAND memory 100 and outputs the read data to the host.

The NAND memory 100 is, for example, a NAND flash memory. Reads and writes are performed on the NAND flash memory in units of data called page data. Page data is written to one page present on a word line in the NAND flash memory. In this case, in a single-level cell (SLC) area, memory cells connected to one word line in common correspond to one page. On the other hand, in a multi-level cell (MLC) area, memory cells connected to one word line in common correspond to a plurality of pages. For example, in a triple-level cell (MLC) area, memory cells connected to one word line in common correspond to three pages.

The NAND controller 200 comprises a central processing unit (CPU) core 210, a random access memory (RAM) for data 220, a NAND interface (I/F) 230, a host I/F 240, an internal data bus 250, a RAM/read-only memory (ROM) for command 260, and an error correction code (ECC) unit 300. The CPU core 210, the RAM for data 220, the NAND I/F 230, the host I/F 240, and the ECC unit 300 are connected together by the internal data bus 250.

The CPU core 210 transmits and receives data to and from the host via the host I/F 240, and transmits and receives data to and from the NAND memory 100 via the NAND I/F 230. That is, the CPU core 210 functions as a read controller or reading unit that reads data from the NAND memory 100 or as a write controller or writing unit that writes data to the NAND memory 100.

Firmware (FW) executed on the CPU core 210 carries out address management including limitation of the number of rewrites, for the NAND memory 100. Moreover, the FW controls the entire NAND memory 100 in accordance with an input command from the host.

The RAM for data 220 stores an address translation table, which is needed for the address management, information on abnormal circuits, and the like. The RAM/ROM for command 260 stores a control program for the NAND memory 100 and the like.

The ECC unit 300 includes an ECC encoder and an ECC decoder (neither of the ECC encoder and decoder is shown in the drawings). The ECC encoder encodes data to be written to the NAND memory 100. The ECC decoder decodes encoded data read from the NAND memory 100.

When ECC encoded data has been written to the NAND memory 100, even if data read from the NAND memory 100 includes a certain level of error, the error can be corrected by performing ECC decode on the data.

As the ECC, a binary linear code is typically adopted. The binary linear code may be, for example, a Bose-Chaudhuri-Hocquenghem (BCH) code or a certain low-density parity-check (LDPC) code. According to the first embodiment, the ECC is assumed to be the binary linear code. However, the ECC may be a non-binary linear code; and in this case, in the description below, “exclusive OR” should be replaced with “addition for each symbol”.

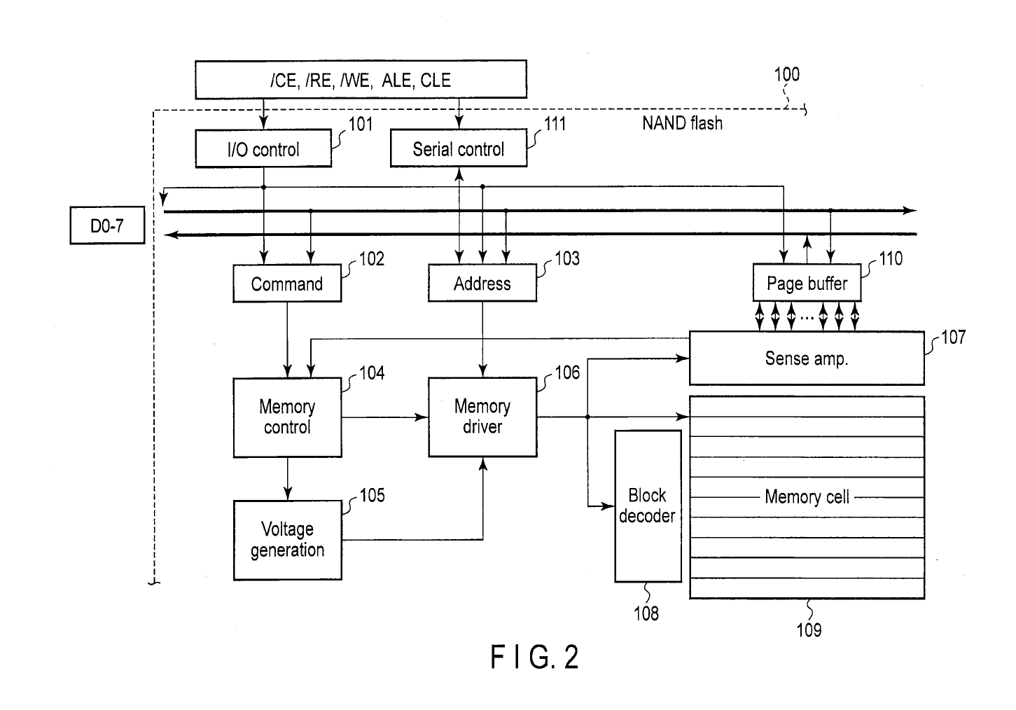

As illustrated in FIG. 2, the NAND memory 100 comprises an I/O control unit 101, a command unit 102, an address unit 103, a memory control unit 104, a voltage generation unit 105, a memory driver 106, a sense amplifier 107, a block decoder 108, a memory cell 109, a page buffer 110, and a serial control unit 111.

The I/O control unit 101 receives control signals via various control input terminals /CE, /RE, /WE, ALE, and CLE. In accordance with the control signals, the I/O control unit 101 outputs a command to the command unit 102, outputs an address to the address unit 103, or outputs or receives data to or from the page buffer 110

The command unit 102 receives a command from the I/O control unit 101. The command unit 102 decodes the command. To implement an operation (for example, an erase operation, a read operation, or a write operation) indicated by the command, the command unit 102 provides the memory control unit 104 with an instruction on further detailed operations based on the result of decoding of the command.

The address unit 103 receives an address from the I/O control unit 101. The address unit 103 obtains an intra-page address and a page address by decoding the address. The address unit 103 outputs the intra-page address to the page buffer 110 and outputs the page address to the memory driver 106.

The memory control unit 104 performs a series of detailed operations in accordance with an instruction from the command unit 102. The operations indicated by the command are realized by performing the series of operations in an appropriate order.

The voltage generation unit 105 generates various signals with voltages of different levels for performing the series of detailed operations. For example, the various signals may have a voltage higher than 20 V or a very low voltage of about several mV.

Based on the page address from the address unit 103 and the instruction on the detailed operations from the memory control unit 104, the memory driver 106 selects among the various signals from the generation unit 105 and outputs a selected signal to the sense amplifier 107, the block decoder 108, and the memory unit 109. The memory driver 106 operates in this manner to perform each of the series of detailed operations.

The sense amplifier 107 includes a sense circuit for reading data from the memory cell 109 and a circuit for writing data from the page buffer 110 to the memory cell 110.

The block decoder 108 decodes a block address. The block decoder 108 selects a block indicated by the decoded block address. The operation indicated by the command is applied only to the selected block.

The memory cell 109 corresponds to a memory cell array formed by a plurality of memory cells for storing data. The memory cell 109 is divided into a plurality of blocks. The size of a block is, for example, about 2 MB. Moreover, each block is divided into a plurality of (for example, 256) pages. The size of a page is, for example, about 8 KB or about 16 KB. Data erasure needs to be performed in units of blocks. On the other hand, data read or write needs to be performed in units of pages.

The page buffer 110 writes and reads data to and from the memory cell 109 via the sense amplifier 107. During read, read data for one page is stored in the page buffer at a time. During write, the data for one page stored in the page buffer 110 is written at a time. That is, the page buffer 110 is capable of storing page data read from the memory cell 109.

Moreover, the page buffer 110 outputs read data to data I/O terminals D0 to D7, and receives write data from the data I/O terminals D0 to D7. Data is serially transmitted between the page buffer 110 and the data I/O terminals D0 to D7 in units of bytes.

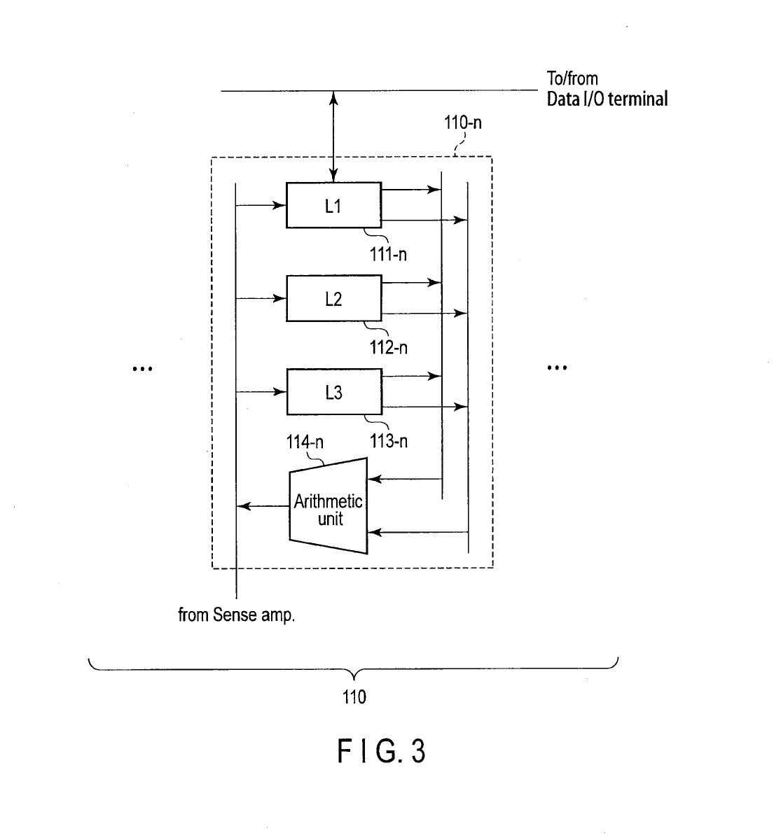

Specifically, as illustrated in FIG. 3, the page buffer 110 comprises a plurality of unit circuits including unit circuit 110-n. Denoted by n is an index for identifying each unit circuit, and n is given by, for example, a serial number. Each of the unit circuits handles 1 bit data included in the page data.

In other words, the page buffer 110 comprises unit circuits that are equal to the page size [bits] in number.

The unit circuit 110-n comprises a latch L1 (111-n), a latch L2 (112-n), a latch L3 (113-n), and an arithmetic unit 114-n. The unit circuit 110-n can receive data read from the memory cell 109 via the sense amplifier 107 and store the data in one of the latches L1, L2, and L3. The unit circuit 110-n can move the data stored in one of the latches L1, L2, and L3 to another latch.

The unit circuit 110-n can output the data stored in the latch L1 to the data I/O terminals D0 to D7. The unit circuit 110-n can receive data through the data I/O terminals D0 to D7 and store the data in the latch L1. The unit circuit 110-n can perform a logical operation (for example, exclusive OR) between the data stored in one of the latches L1, L2, and L3 and the stored in another latch.

The serial control unit 111 controls data transfer between the page buffer 110 and the data I/O terminals D0 to D7. During read, the serial control unit 111 transfers the data stored in the page buffer 110 to the data I/O terminals D0 to D7 each time a /RE signal is asserted. During write, the serial control unit 111 transfers data from the data I/O terminals D0 to D7 to the page buffer 110 each time a /WE signal is asserted.

To reduce the product failure rate of the memory device, it is preferable to suppress a possible read error in the memory device by performing a certain verification process on a write operation. However, for example, in the verification process that involves, each time page data is written, reading the page data, outputting the read data to the controller, and ECC decoding the read data in the controller, the high computational complexity of the ECC decode becomes a problem.

Therefore, the NAND memory device according to this embodiment carries out a verification process on a write operation for a plurality of page data (the plurality of pages typically belongs to the same block) at a time. This allows a valid verification result to be obtained while enabling an effective reduction in the number of times the ECC decode and the output of read data to the controller are carried out.

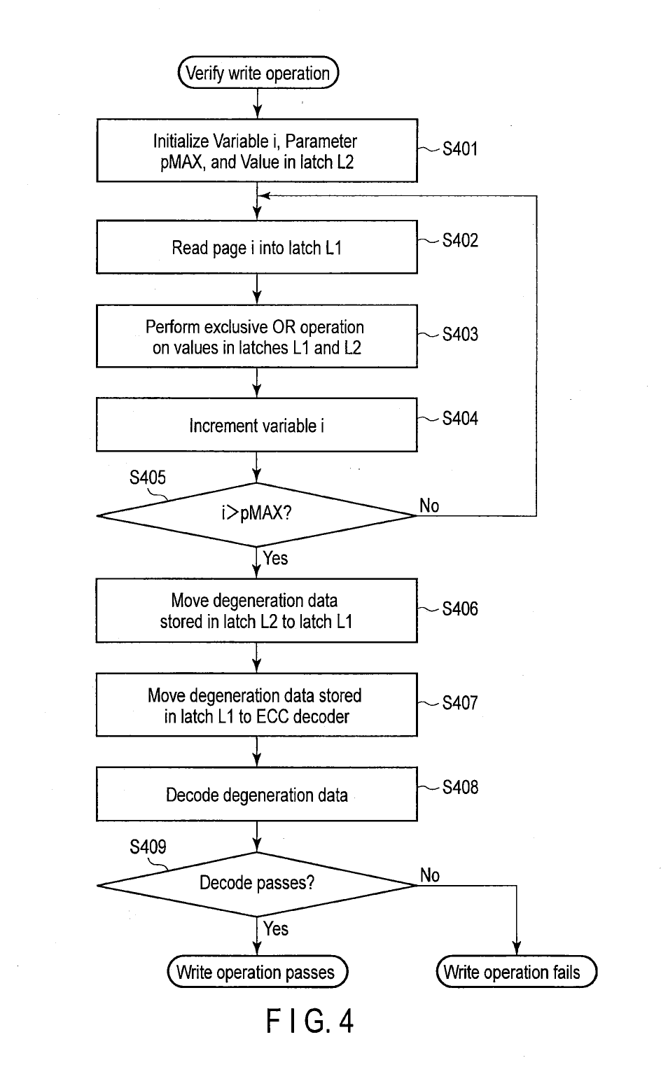

Specifically, the NAND memory device in FIG. 1 can carry out a verification process on a write operation illustrated in FIG. 4.

The process in FIG. 4 is intended for a write operation, which was performed just before, for a plurality of page data (the plurality of pages typically belongs to the same block). The plurality of page data may be used for a recovery process, such as a rewrite process, when the abnormal end (Write Operation Fail) is determined. Hence, the plurality of page data need to be temporarily stored until the write operation is determined to have ended normally (Write Operation Pass). Specifically, the plurality of page data may be stored inside the NAND controller 200 (for example, the RAM for data 220) or in a more reliable area inside the memory cell 109 (for example, the SLC is more preferable in comparison with the MLC area and a TLC area).

When the process in FIG. 4 starts, a variable i, a parameter pMAX, and a value stored in the latch L2 in the page buffer 110 are initialized (step S401). Specifically, “1” is substituted into the variable i, the total number (an integer of 2 or larger) of pages intended for verification is substituted into the parameter pMAX, and “0” is stored in each latch L2. The variable i is used as a counter. After step S401, the process proceeds to step S402.

In step S402, page data (page i) corresponding to the i^{th} page is read from the memory cell 109 and stored in the latch L1 in the page buffer 110. Then, an exclusive OR operation between the value stored in each latch L1 and the value stored in each latch L2 is performed by each arithmetic unit in the page buffer. The result of the operation is stored in the latch L2 (step S403).

Then, the variable i is incremented by one (step S404). If the variable i is larger than the parameter pMAX, the process proceeds to step S406. Otherwise the process returns to step S402 (step S405).

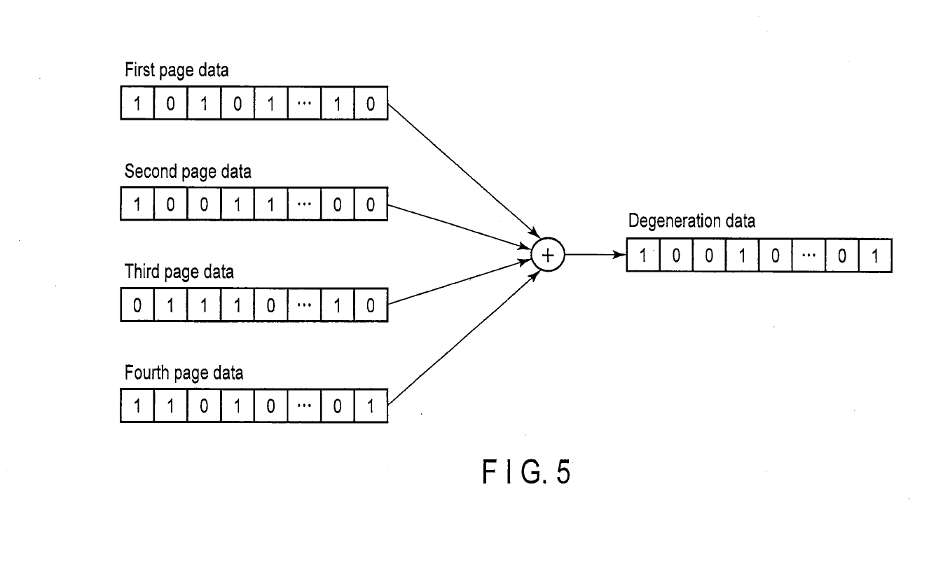

By repeating a loop process from step S402 to step S405, the result of the exclusive OR operation on the page data corresponding to the 1^{st} page to the pMAX^{th} page is stored in the latch L2. The result of the operation is hereinafter referred to as degeneration data. For example, as shown in FIG. 5, for pMAX=4, the degeneration data is generated by performing an exclusive OR operation on the first page data to the fourth page data. That is, the page buffer 110 is capable of generating degeneration data by performing an exclusive OR operation on a plurality of page data from the memory cell 109.

In step S406, the degeneration data stored in the latch L2 is moved to the latch M. Then, the degeneration data stored in the latch L1 is moved to the ECC decoder in the ECC unit 300 via the data I/O terminals D0 to D7, the NAND I/F 230, and the internal data bus 250 (step S407).

The ECC decoder decodes the degeneration data moved in step S407 (S408). Then, the ECC decoder determines whether the degeneration data passes the ECC decode or not (step S409). In general, “ECC decode passes” means that decoded data satisfies parity check. Specifically, “ECC decode passes” means that a temporarily estimated word generated for the data to be decoded matches any codeword.

When the ECC decode in step S408 passes (step S409), the write operation for the plurality of page data, for which the process in FIG. 4 is intended, is determined to have ended normally. As described below, when the ECC decode of the degeneration data passes, the ECC decode is also very likely to pass for each of the plurality of page data used to generate the degeneration data. On the other hand, if the ECC does not pass in step S408 (step S409), the write operation for the plurality of page data, for which the process in FIG. 4 is intended, is determined to have ended abnormally. If the operation is determined to have ended abnormally, various recovery processes may further be carried out.

Various examples of the recovery process are introduced below. However, the recovery process that can be adopted for the NAND memory device according to this embodiment is not limited to these examples. Any recovery process different from these examples may be adopted depending on the design concept of the NAND memory device.

For example, if, in the process in FIG. 4, the operation is determined to have ended abnormally, a block to which the plurality of pages used to generate the degeneration data can immediately be recorded as a bad block or a half-bad block. In this case, the bad block or the half-bad block can be defined in various manners. For example, the bad block may be defined as a block completely excluded from a usable area of the memory cell 109. The half-bad block may be defined as a block partly excluded (for example, in units of pages) from the usable areas of the memory cell 109.

Record information on bad blocks or record information on half-bad blocks is managed, for example, on a list created in the memory cell 109. Then, the plurality of page data is rewritten. For example, the write controller may cause the nonvolatile memory 100 to rewrite the plurality of page data to normal blocks other than the bad blocks and the half-bad blocks, or to the areas of the half-bad blocks that are not excluded from the usable areas.

On the other hand, according to the process in FIG. 4, it is determined that the operation has ended abnormally when the ECC decode of the degeneration data does not pass. However, even when the ECC decode of the degeneration data does not pass, the ECC decode of each of the plurality of page data used to generate the degeneration data may pass. In short, that the ECC decode of the degeneration data does not pass, does not necessarily mean that the block to which the plurality of pages used to generate the degeneration data belong is bad.

Thus, for example, if the process in FIG. 4 determines the operation to have ended abnormally, it may be verified whether or not each ECC decode of the plurality of page data used to generate the degeneration data passes. When, as a result, the ECC decode of all the page data passes, the write controller can omit rewriting because the page data can be correctly read. On the other hand, when the ECC decode of at least one page data does not pass, the block to which the page belongs may be recorded as a bad block or a half-bad block, and then, the write controller may rewrite the page data for which the ECC decode does not pass.

The validity of the verification result obtained by the process in FIG. 4 will be described below. In general, the following equation holds true between a parity check matrix H and a codeword (vector) C defined by the parity check matrix H.

H×C=0

where × represents a multiplication between the matrix and the vector.

When read data (vector) from the memory cell 109 is denoted by D, the read data D corresponds to one obtained by adding a certain error (vector) E to a certain codeword (i.e., write data) C. That is, the following equation holds true between the read data D and the codeword C and the error E.

D=C+E

where + represents exclusive OR operation since the ECC is assumed to be a binary liner code. If the ECC is a non-binary linear code, + represents addition for each symbol.

Moreover, the degeneration data represents the result from exclusive OR on read page data in the 1^{st} page 1 to the pMAX^{th} page. Therefore, the following equation also holds true.

$$\begin{matrix}H \times {D}_{eor} = H \times {\sum }_{i = 1}^{pMAX} {D}_{i} \\ = H \times {\sum }_{i = 1}^{pMAX} ( {C}_{i} + {E}_{i} ) \\ = H \times {\sum }_{i = 1}^{pMAX} {E}_{i}\end{matrix}$$

Dₑₒᵣ represents the degeneration data (vector). Dᵢ represents the read page data in the i^{th} page. Cᵢ represents the Write page data in the i^{th} page. Eᵢ represents the error in the i^{th} page. Therefore, the degeneration data Dₑₒᵣ can pass the ECC decode when the following Hamming weight (A) is less than or equal to the number of correctable bits that depends on the design of the ECC.

$${H}_{w} ( {\sum }_{i = 1}^{pMAX} {E}_{i} ) \qquad ( A )$$

Where H_{w}(x) is a function that returns the Hamming weight of a vector x.

On the other hand, to allow all the page data D₁, . . . , DₚMAX used to generate the degeneration data to pass the ECC decode, the following Hamming weight (B) needs to be less than or equal to the number of correctable bits.

$${max}_{i} \{ {H}_{w} ( {E}_{i} ) \} \qquad ( B )$$

The following inequality is very likely to hold true between the two Hamming weights (A) and (B).

$${max}_{i} \{ {H}_{w} ( {E}_{i} ) \} \leq {H}_{w} ( {\sum }_{i = 1}^{pMAX} {E}_{i} ) \qquad ( 1 )$$

Hence, when the ECC decode of the degeneration data Dₑₒᵣ passes, all the read page data D₁, . . . , DₚMAX used to generate the degeneration data are also very likely to be able to pass the ECC decode.

If the inequality (1) does not hold true and the Hamming weight (B) is larger than the number of correctable bits, even when the ECC decode of the degeneration data Dₑₒᵣ passes, some read page data can not pass the ECC decode. However, the probability of occurrence of such an event is very low. Moreover, the probability of occurrence of such an event can be brought into an allowable range by adjusting the design of the ECC (particularly the number of correctable bits), the number of pages used to generate the degeneration data, or the like.

As described above, the NAND memory device according to the first embodiment generates degeneration data by adding a plurality of page data for each symbol, and verifies whether or not the write operation for the plurality of page data has been successful depending on whether or not the ECC decode of the degeneration data passes. In this case, when the ECC decode of the degeneration data passes, each of the plurality of page data used to generate the degeneration data is very likely to pass ECC decode. Thus, according to the NAND memory device, compared to a case where it is verified whether or not the write operation of each of the plurality of page data has been successful, a valid verification result can be obtained while effectively reducing the number of times the ECC decode and the output of read data to the controller are carried out. That is, the verification of the write operation enables a reduction in the product failure rate of the NAND memory device, while suppressing a decrease in operating speed and an increase in power consumption.

### Second Embodiment

The verification process described in the first embodiment may be carried out for various purposes. For example, the verification process may be applied to deal with a process failure on a word line (WL) level.

When data is written to the NAND memory, usually, it is verified whether or not an operation of writing to a block has been successful, in a simplified manner based on the write state (specifically, the magnitude of a threshold voltage). However, when a certain WL is broken or short-circuited to an adjacent WL, in spite of an affirmative verification result obtained during write to a block on the certain WL, there is a possibility that data have not been written in many memory cells in the block, and data may not be correctly read from the block even if the ECC decode is performed. This problem becomes more serious as the NAND memory is increasingly miniaturized.

Thus, the NAND memory device according to the second embodiment may generate degeneration data based on page data written to some of a plurality of pages each present on at least one target WL and verifies whether or not the ECC decode of the degeneration data passes. The verification result is utilized to determine whether or not a process failure has occurred on the target WL.

Specifically, if the target WL belongs to an MLC area or a TLC area, a plurality of pages (for example, Upper page and Lower page) are present on the target WL. Then, the NAND memory device may generate degeneration data using page data written to some of the plurality of pages instead of all of the plurality of pages.

For example, on the assumption that the target WL belongs to the TLC area, when degeneration data is generated using only Upper page data, the number of times the ECC decode and the output of read data to the NAND controller are performed can be reduced to one-third, compared to when degeneration data is generated using page data written to all three pages.

As described above, the NAND memory device according to the second embodiment generates degeneration data based on page data written to some of the plurality of pages present on at least one target WL and verifies whether or not the ECC decode of the degeneration data passes. The verification result is used to determine whether or not a process failure is present on the target WL. Hence, according to the NAND memory device, a verification result may be obtained which is useful for determining whether or not a process failure is present on the WL level while reducing the number of times the ECC decode and the output of read data to the NAND controller are carried out.

### Third Embodiment

The verification process described in the first embodiment may be omitted in a situation where a write operation is unlikely to fail. The NAND memory device according to the third embodiment effectively suppresses a decrease in operating speed and an increase in power consumption which are associated with the execution of the verification process, by adaptively omitting execution of a verification process (i.e., generation of degeneration data) (or lowering the frequency executed for a verification process).

For example, in a multilevel NAND memory, an MLC area and an SLC area that is more reliable than the MLC area may be mixed together. In general, an operation of writing to a reliable area is unlikely to fail, and thus, the NAND memory device according to this embodiment may omit a verification process for an operation of writing to the SLC area.

Furthermore, in the NAND memory, it is necessary to perform erasure on a certain block before writing to the block. However, as erasures and writes are repeated (that is, as the number of write/erase (W/E) operations performed increases), the operation of writing to the block is more likely to fail. Thus, the NAND memory device according to the third embodiment may omit a verification process for an operation of writing to a target block when the number of W/E operations performed on this block is smaller than a threshold. When the verification process is omitted in such a situation, few verification processes are carried out during a certain period after the use of the NAND memory device is started. This allows write operations to be carried out at high speed and at reduced power consumption.

As described above, the NAND memory device according to the third embodiment omits the verification process in a situation where the write operation is unlikely to fail (for example, during an operation of writing to the SLC area and during an operation of writing to a block for which the number of W/E operations performed is smaller than a threshold). Hence, according to the NAND memory device, a decrease in operating speed and an increase in power consumption associated with execution of the verification process can be effectively suppressed.

### Fourth Embodiment

As illustrated in FIG. 1, in the NAND memory device according to the first embodiment, the ECC unit is provided in the NAND controller. However, the ECC unit may be provided on the same chip as that on which the NAND memory is provided (that is, the ECC unit may be incorporated in the NAND memory). In a NAND memory device according to this embodiment, an ECC unit is incorporated in a NAND memory.

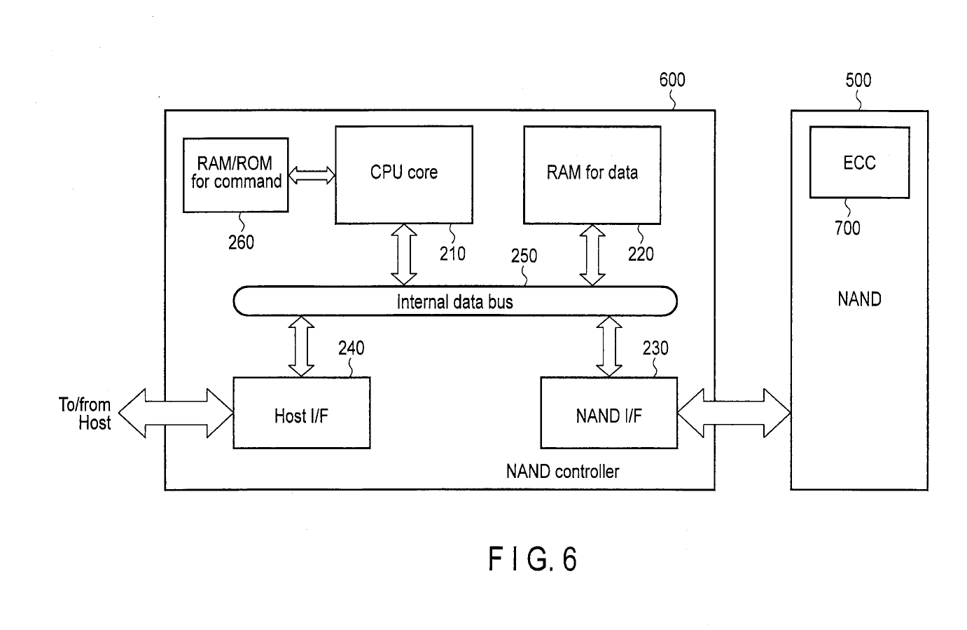

As illustrated in FIG. 6, the NAND memory device according to the fourth embodiment includes a NAND memory 500 and a NAND controller 600. As shown in FIG. 6, the ECC unit 700 is incorporated in the NAND memory 500. The ECC unit 700 includes an ECC encoder 710 and an ECC decoder 720 described below.

The NAND controller 600 comprises a CPU core 210, a RAM for data 220, a NAND I/F 230, a host I/F 240, an internal data bus 250, and a RAM/ROM for command 260. That is, the NAND controller 600 in FIG. 6 corresponds to the NAND controller 200 in FIG. 1 from which the ECC unit 300 is removed.

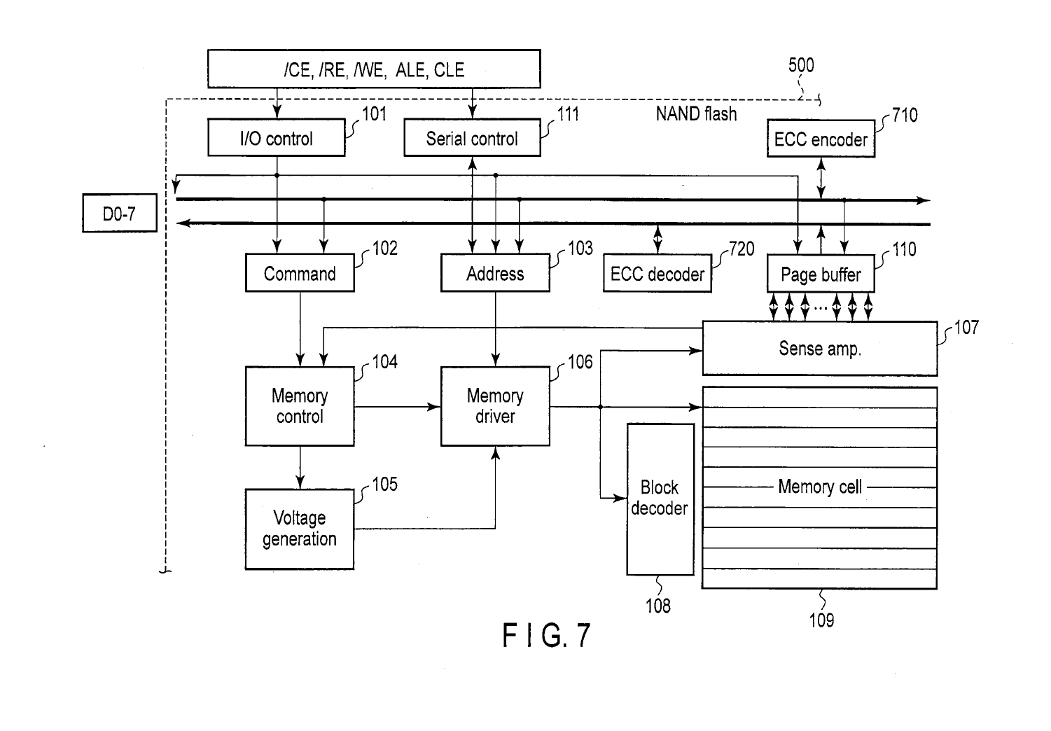

As illustrated in FIG. 7, the NAND memory 500 comprises an I/O control unit 101, a command unit 102, an address unit 103, a memory control unit 104, a voltage generation unit 105, a memory driver 106, a sense amplifier 107, a block decoder 108, a memory cell 109, a page buffer 110, a serial control unit 111, an ECC encoder 710, and an ECC decoder 720. That is, the NAND memory 500 in FIG. 7 corresponds to the NAND controller 100 in FIG. 2 to which the ECC encoder 710 and the ECC decoder 720 are added.

The ECC encoder 710 ECC encodes data written to the NAND memory 500. The ECC decoder 720 ECC decodes data read from the NAND memory 500.

The NAND memory device according to this embodiment also carries out a verification process identical or similar to the verification process illustrated in FIG. 4. However, in the NAND memory device, since the ECC unit 700 is incorporated in the NAND memory 500, the verification process is implemented by an internal process of the NAND memory 500. Thus, no degeneration data is output to the NAND controller 600.

As described above, in the NAND memory device according to the fourth embodiment, the ECC unit is incorporated in the NAND memory and the verification process identical or similar to the verification process in the first to third embodiments is implemented by the internal process of the NAND memory 500. Thus, according to this NAND memory device, effects identical or similar to the effects in the first to third embodiments can be obtained.

At least a part of the processing in each of the above-described embodiments can be implemented by using a general-purpose computer as basic hardware. A program for implementing the processing in each of the above-described embodiments, which is stored in a computer readable storage medium, may be provided. The program is stored in a storage medium as a file in an installable format or a file in an executable format. The storage medium may be a magnetic disk, an optical disc (CD-ROM, CD-R, DVD, or the like), a magneto-optical disk (MO or the like), a semiconductor memory, or the like. Any of these storage media may be used provided that the storage medium can store the program and that a computer can read data from the storage medium. Furthermore, the program implementing the processing in the above-described embodiments may be stored in a computer (server) connected to a network such as the Internet and downloaded into a computer (client) via the network.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A nonvolatile semiconductor memory device comprising:
a nonvolatile memory which comprises a memory cell array and a buffer, the buffer being capable of storing page data read from the memory cell array and generating degeneration data by performing an exclusive OR operation on a plurality of page data read from the memory cell array;
a controller which comprises an ECC decoder and a write controller,
the ECC decoder being capable of performing ECC decode on the degeneration data input from the nonvolatile memory and determining whether the degeneration data passes the ECC decode or not,
the write controller being capable of causing the nonvolatile memory to rewrite the plurality of page data when the degeneration data does not pass the ECC decode.

2. The device according to claim 1, wherein the buffer comprises a plurality of latches and an arithmetic circuit, and generates the degeneration data by performing an exclusive OR operation on page data read from the memory cell array onto the latches to generate degeneration data by using the arithmetic circuit.

3. The device according to claim 1, wherein the generating the degeneration data is omitted when the plurality of page data are written to a block for which a number of write/erase (W/E) operations performed thereon is smaller than a threshold.

4. The device according to claim 1, wherein the generating the degeneration data is omitted when the plurality of page data are written to a single level cell (SLC) area.

5. The device according to claim 1, wherein the ECC decoder ECC decodes each of the plurality of page data when ECC decode of the degeneration data does not pass.

6. The device according to claim 5, wherein the write controller omits rewrite of the plurality of page data when ECC decode passes for each of the plurality of page data.

7. The device according to claim 5, wherein a block is recorded as a bad block or a half-bad block if ECC decode does not pass for at least one of the plurality of page data; the page data, which the ECC decode does not pass, being written to the block; and the write controller being capable of causing the nonvolatile memory to rewrite the page data, which the ECC decode does not pass, to a normal block other than the bad block and the half-bad block or to an area of the half-bad block which is not excluded from usable areas.

8. The device according to claim 1, wherein a block to which the plurality of page data are written is recorded as a bad block if ECC decode of the degeneration data does not pass, the write controller being capable of causing the nonvolatile memory to rewrite the plurality of page data to a normal block other than the bad block.

9. The device according to claim 1, wherein a block to which the plurality of page data are written is recorded as a half-bad blocks if ECC decode of the degeneration data does not pass, the write controller being capable of causing the nonvolatile memory to rewrite the plurality of page data to a normal block other than a bad block and the half-bad blocks or to areas of the half-bad blocks which are not excluded from usable areas.

10. The device according to claim 1, wherein the page data is encoded using a binary linear ECC code.

11. A nonvolatile semiconductor memory device comprising:
a nonvolatile memory which comprises a memory cell array, a buffer and an ECC decoder, the buffer being capable of storing page data read from the memory cell array and generating degeneration data by performing an exclusive OR operation on a plurality of page data read from the memory cell array, the ECC decoder being capable of performing ECC decode on the degeneration data input from the nonvolatile memory and determining whether the degeneration data passes ECC decode or not; and
a controller which comprises a write controller, the write controller being capable of causing the nonvolatile memory to rewrite the plurality of page data when the degeneration data does not pass ECC decode.
